(19) United States
(12) Patent Application Publication
(10) Pub. No.: US 2011/0049741 A1
(43) Pub. Date: Mar. 3, 2011

(54) METHOD OF MAKING CERAMIC BODIES HAVING REDUCED SHAPE VARIABILITY

(76) Inventors: Dennis M. Brown, Elmira, NY (US); Steve J. Caffery, Rochester, NY (US); Daniel Edward McCauley, Watkins Glen, NY (US); David Robinson Treacy, JR., Horsehead, NY (US); Casey Allen Volino, Tioga, PA (US)

(21) Appl. No.: 12/550,620

(22) Filed: Aug. 31, 2009

(51) Int. Cl. B29C 47/92

(52) U.S. Cl. 264/40.1

(57) ABSTRACT

A method of making ceramic bodies having reduced shape variability. Such ceramic bodies include extruded-to-shape substrates and diesel particulate filters. Principal components analysis is used to generate a small number of uncorrelated or independent components from a larger set of inter-correlated measurements. The uncorrelated components can then be used during the forming process to control the shape of ceramic bodies and reduce variability of such shapes. A method for quantifying and subsequently reducing the shape variability of is also described.

### BACKGROUND

The ability to produce ceramic bodies that meet specifications depends on the ability to predict and adjust processing/manufacturing parameters and diagnose and correct shape issues. While specific shape families and their root causes are known, there is no methodology for quantitatively assessing shape families. Current parameterizations, such as template, tubegauge, major axis length, and minor axis length are insufficient for proper assessment of shape-induced yield loss as they focus primarily on size and obscure shape information.

### SUMMARY

A method for quantifying and subsequently reducing the shape variability of ceramic bodies, such as extruded-to-shape substrates and diesel particulate filters, is provided. Principal components analysis is used to generate a small number of uncorrelated or independent components from a larger set of inter-correlated measurements. The uncorrelated components can then be used during the forming process to control the shape of ceramic bodies and reduce the variability of such shapes. A method of making ceramic bodies having reduced shape variability is also described.

Accordingly, one aspect of the disclosure is to provide a method of making ceramic bodies having reduced shape variability. The method comprises the steps of: providing a first ceramic body having a contour shape; quantifying shape component contributions to the contour shape; and adjusting manufacturing parameters for making subsequent ceramic bodies based on the quantified shape contributions to the contour shape.

A second aspect of the disclosure is to provide a method of controlling contour shapes of ceramic bodies. The method comprises the steps of: providing a first ceramic body; measuring deviations from a predetermined contour shape on the surface of the first ceramic body, wherein adjacent deviations are correlated with each other; transforming correlated deviations into independent principal components; combining the independent principal components to obtain an original shape; and adjusting manufacturing parameters for the ceramic bodies based on the independent principal components obtained for the first ceramic body to make a second green ceramic body having contours that are within a tolerance of a predetermined contour shape.

Yet another aspect of the disclosure is to provide a method of making a plurality of green bodies comprising a ceramic material. The method comprises the steps of: providing a first green body; measuring deviations from a predetermined contour on the surface of the ceramic body, wherein adjacent deviations are correlated to each other; transforming the correlated deviations into independent principal components; linearly combining the independent principal components to obtain an original shape; and adjusting manufacturing parameters based on the principal components to make a second green ceramic body having contours that are within a tolerance of the predetermined contour.

These and other aspects, advantages, and salient features will become apparent from the following detailed description, the accompanying drawings, and the appended claims.

### BRIEF DESCRIPTION OF THE DRAWINGS

FIG. 1 is a schematic perspective view of a ceramic body;

FIGS. 2a-c are schematic representations of examples of extrusion flow fronts and the cross-sections associated with such extrusion flow fronts;

FIGS. 3 a-d are schematic representations of shape families;

FIG. 4a is a plot of template measurements for fired ceramic bodies versus template measurements of green ceramic bodies;

FIG. 4b is a plot of tubegauge measurements for fired ceramic bodies versus tubegauge measurements of green ceramic bodies;

FIG. 4c is a plot of major axis measurements for fired ceramic bodies versus major axis length measurements of green ceramic bodies;

FIG. 4d is a plot of minor axis length measurements for fired ceramic bodies versus minor axis length measurements of green ceramic bodies;

FIGS. 5a-d are examples of the shape families shown in FIGS. 3a-d generated by principal component analysis; and

FIGS. 6a-d are plots of relationships between green bodies and fired bodies for the shape families shown in FIGS. 3a-d.

### DETAILED DESCRIPTION

In the following description, like reference characters designate like or corresponding parts throughout the several views shown in the figures. It is also understood that, unless otherwise specified, terms such as “top,” “bottom,” “outward,” “inward,” and the like are words of convenience and are not to be construed as limiting terms. In addition, whenever a group is described as comprising at least one of a group of elements and combinations thereof, it is understood that the group may comprise, consist essentially of, or consist of any number of those elements recited, either individually or in combination with each other. Similarly, whenever a group is described as consisting of at least one of a group of elements and combinations thereof, it is understood that the group may consist of any number of those elements recited, either individually or in combination with each other. Unless otherwise specified, a range of values, when recited, includes both the upper and lower limits of the range.

Referring to the drawings in general, it will be understood that the illustrations are for the purpose of describing particular embodiments and are not intended to limit the disclosure or appended claims thereto. The drawings are not necessarily to scale, and certain features and certain views of the drawings may be shown exaggerated in scale or in schematic in the interest of clarity and conciseness.

The ability to produce ceramic bodies that meet specific contour specifications depends on the ability to predict and adjust forming parameters for shrinkage, and to diagnose and correct shape issues. In particular, such shape issues relate to deviations from an “ideal” or desired shape or contour (also referred to herein as a “target contour”) such as, for example, the shapes of a face or cross-section of a ceramic filter body. Such a face may, for example, ideally be oval, polygonal, or circular. While the description of contour shapes and deviations from said contour shapes is limited to oval or elliptical shapes, contours, and/or profiles, it is understood that the methods described herein are equally applicable to other contours, shapes, and/or profiles that are known in the art such as, but not limited to, cylindrical or circular shapes, polygonal (square, rectangular, hexagonal, octahedral) shapes, and the like.

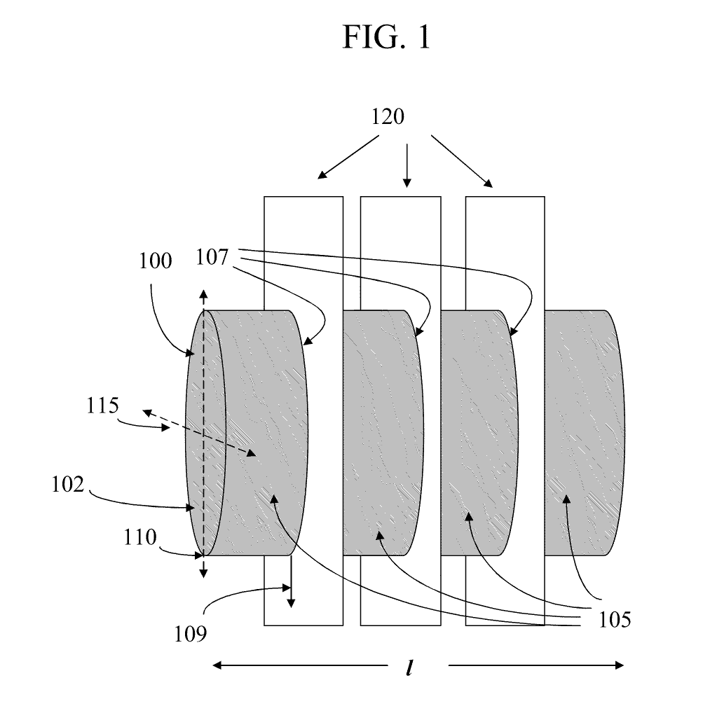

A perspective view of a ceramic body is schematically shown in FIG. 1. In the embodiment shown in FIG. 1, ceramic body 100 has a cylindrical cross section having elliptical or oval faces 102 and an outer surface 105, with major axis 110 and minor axis 115. As used herein, “elliptical” and “oval” are equivalent terms and are used interchangeably. The ceramic body 100 has a contour or outer shape 107. Deviations of the contour shape 107 of the ceramic body 100 from a desired or target contour are determined by measurement techniques, such as laser gauge coordinate measurements machines (LGCMM), which are known in the art. Template is a LGCMM parameter that represents the largest contour that can be completely contained within the measured part periphery, whereas tubegauge is the smallest contour that can completely contain the measured part periphery. The contour 107 of outer surface 105 is measured at intersecting planes 120, which are parallel to oval faces 102. Deviations of contour measured at intersecting planes are typically measured in a direction 107 perpendicular to outer surface 105. In particular, deviations of major and minor axes 110, 115 from a predetermined or desired value are measured.

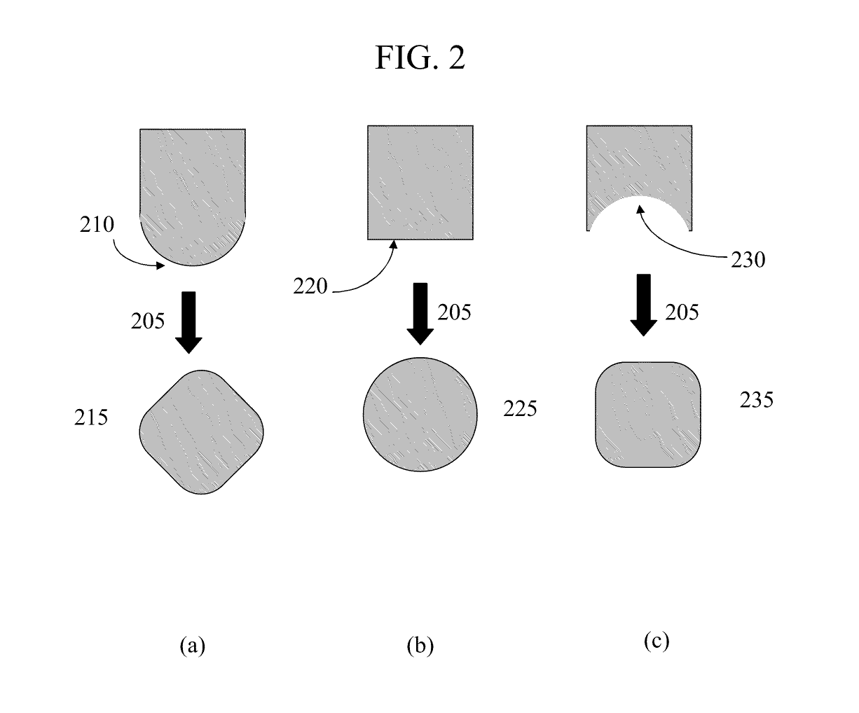

Deviations of a ceramic body from a target contour frequently arise during formation of the ceramic body, particularly when the ceramic body is in a pliant or semi-fluidic state. In extrusion processes, for example, the profile of the “flow front” of the ceramic material with respect to the flow or extrusion direction through the extrusion barrel affects the shape of the cross section of the extruded body. Examples of flow fronts and the cross-sections associated with each flow front are schematically shown in FIGS. 2a-c. In FIG. 2b, the flow front 220 is perpendicular to the extrusion direction 205, the extruded body has an oval or elliptical cross-section 225, which is generally the target contour. In those instances where the flow front 210 is convex or parabolic with respect to extrusion direction 205 (FIG. 2a), the extruded body has a diamond-like or rhombic cross-section 215. A concave flow front 230 produces an extruded body having a rectangular or “boxy” cross-section 235 (FIG. 2c).

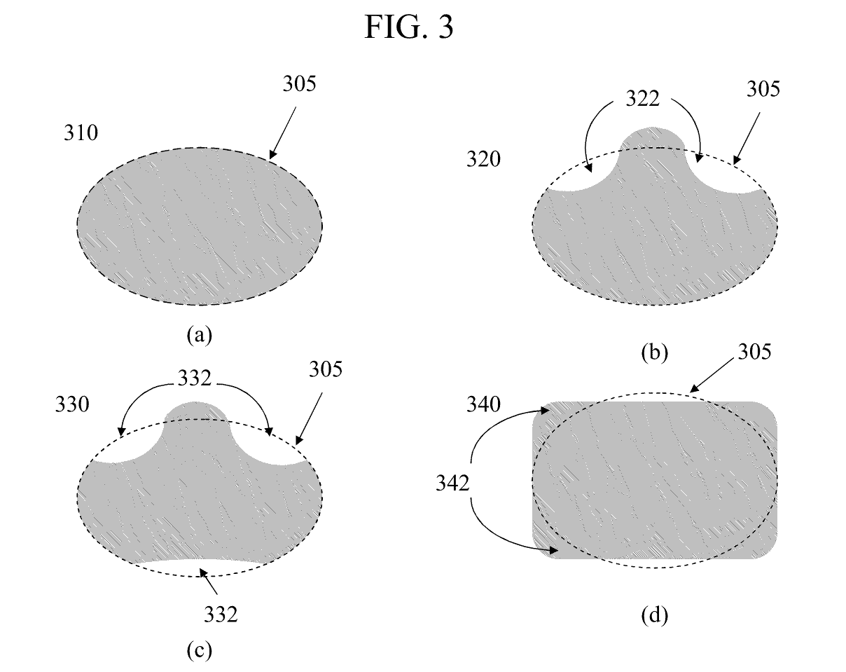

While knowledge of specific shape “families” and their root causes has been available, there has been a lack of methods and means for quantitatively assessing shape families of ceramic bodies of interest. As used herein, the term “shape family” refers to a specific pattern of deviations about a target contour. Typical shape families for elliptical contours are shown in FIG. 3a-d. The shape families shown in FIGS. 3a-d are independent of each other, and can be combined to yield other shape families. It will be appreciated by those skilled in the art that the shape families shown in FIGS. 3a-d are non-limiting examples of possible shape families for elliptical target contours. Shape families other than those shown in FIGS. 3a-d exist for elliptical target contours, and such contours are considered to be within the scope of the present disclosure. Similarly, shape families for other target contours, while not described herein, are considered to be within the scope of the present disclosure.

FIG. 3a represents an elliptical shape 310 that shows no systematic pattern of deviations from the target contour, other than all points on the contour deviate in one direction from the target elliptical shape. FIG. 3b is a “horizontal/vertical” shape 320, in which two portions 322 are “squeezed in” so as to produce negative deviations from the target contour 305 and a third portion between the squeezed in portions 322 is “popped out” to deviate positively from the target contour 305. FIG. 3c is a “pull-in” shape 330, in which three portions 332 of the body are “squeezed in,” deviating negatively from the target contour 305 and a third portion between two of the squeezed in portions 332 is “popped out” to deviate positively from the target contour 305.

The methods described herein address the diagnosis and control of the shape of such ceramic bodies, and represent an enabling technology which will aid in the correction of shape issues, such as lack of conformity of contour shapes of ceramic bodies, and the like. Such correction of shape-related issues is achieved by first quantifying contributions of shape families to the shape of a formed ceramic body. The quantified contributions are then used to clarify which processing and forming procedures and/or parameters are necessary to address the shape-related issues. In a non-limiting example, such parameters for extrusion processes include flow front management via die conditioning, batch temperature control, shrink-plate compensation, and the like.

Accordingly, in one embodiment, a method of making ceramic bodies is provided. In this method, a ceramic body is first provided. In one embodiment, the ceramic body is one the initial bodies in a series of ceramic bodies that are formed. In one embodiment, the ceramic body is a “green” body; i.e., a near net shape body that has been formed by those methods skilled in the art, but has not been converted to its final form by firing at higher temperature (e.g., ≧500° C.) to completely sinter or react and achieve full (or nearly full) density, remove residual moisture, binders, pore formers and the like. Such green bodies may be dried at low temperatures (e.g., ≦200° C.) to remove moisture. In another embodiment, the ceramic body has been fired and formed into a dense shape. The ceramic bodies described herein may be formed by those methods known in the art, such as, but not limited to, extrusion, molding, casting, and the like. In a particular embodiment, the ceramic body is extruded to shape and forms a particulate filter (e.g., a diesel particulate filter) or a catalytic filter substrate. The ceramic body, in one embodiment, comprises at least one of cordierite (magnesium iron aluminum silicate), aluminum titanate, an inorganic carbide (e.g., silicon carbide), zeolite, and combinations thereof.

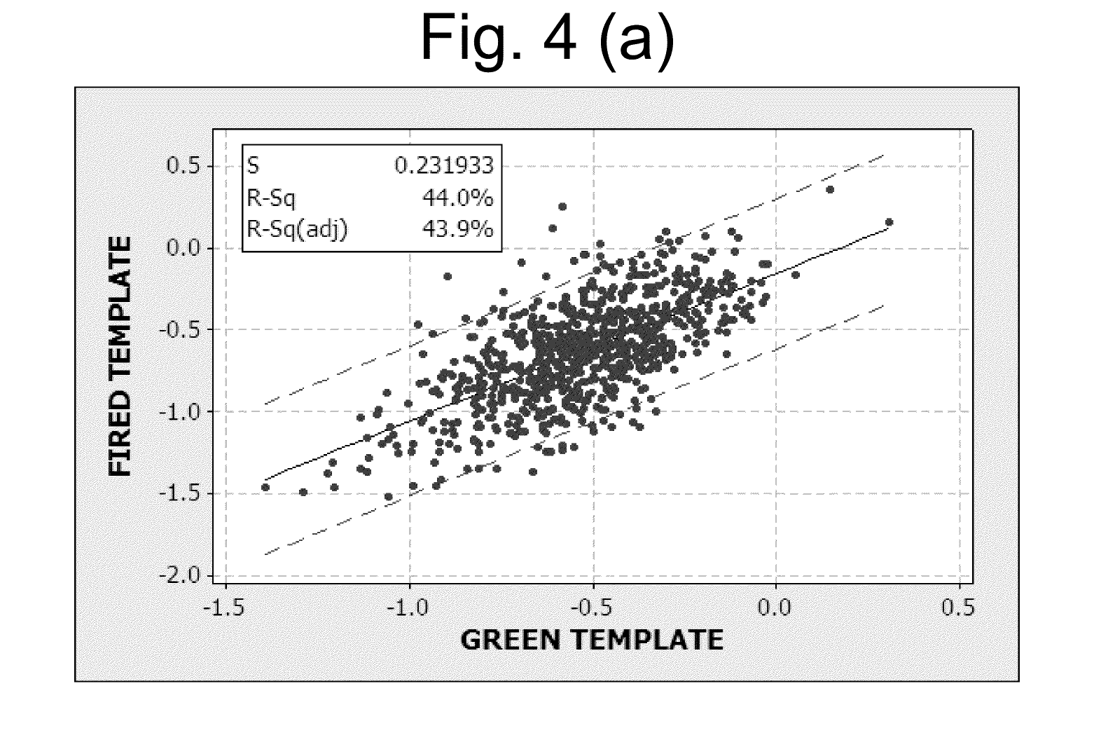

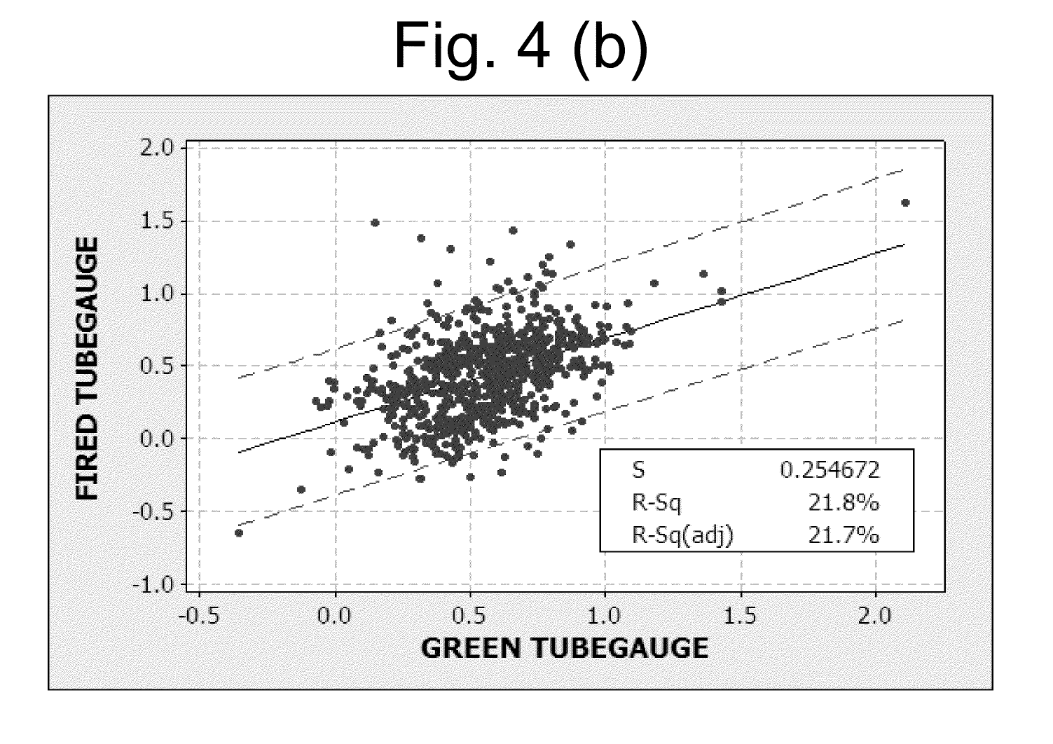

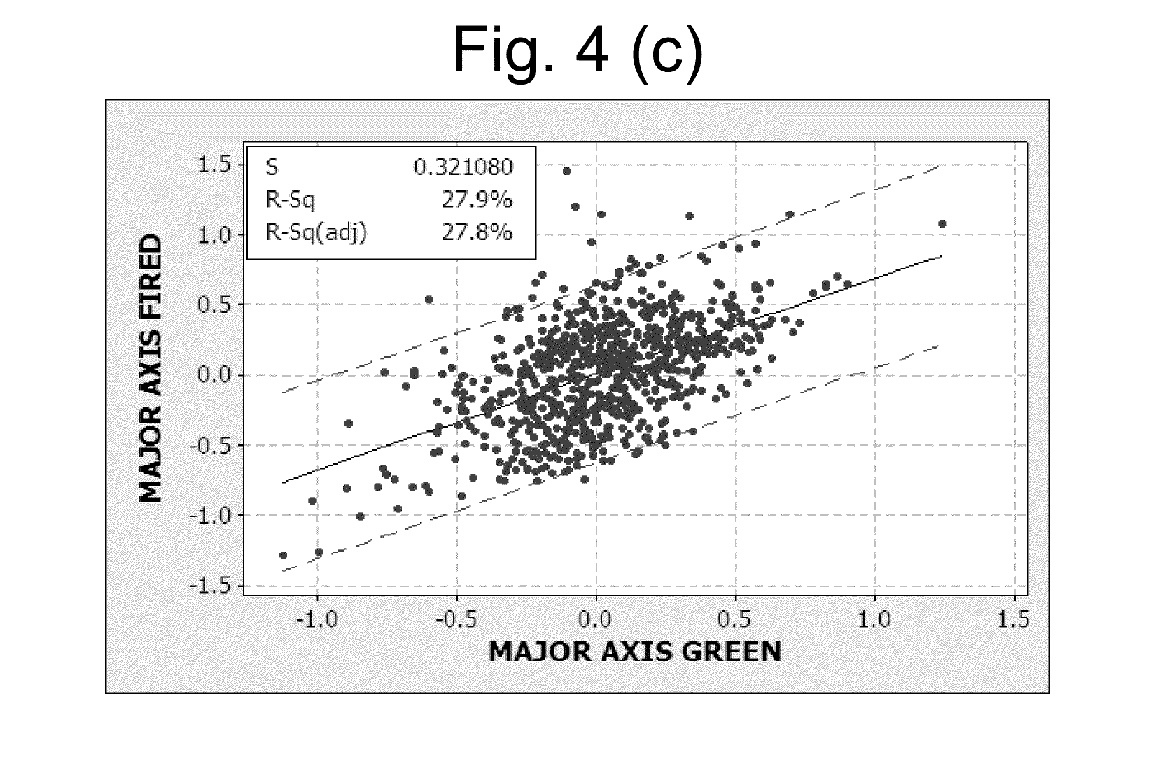

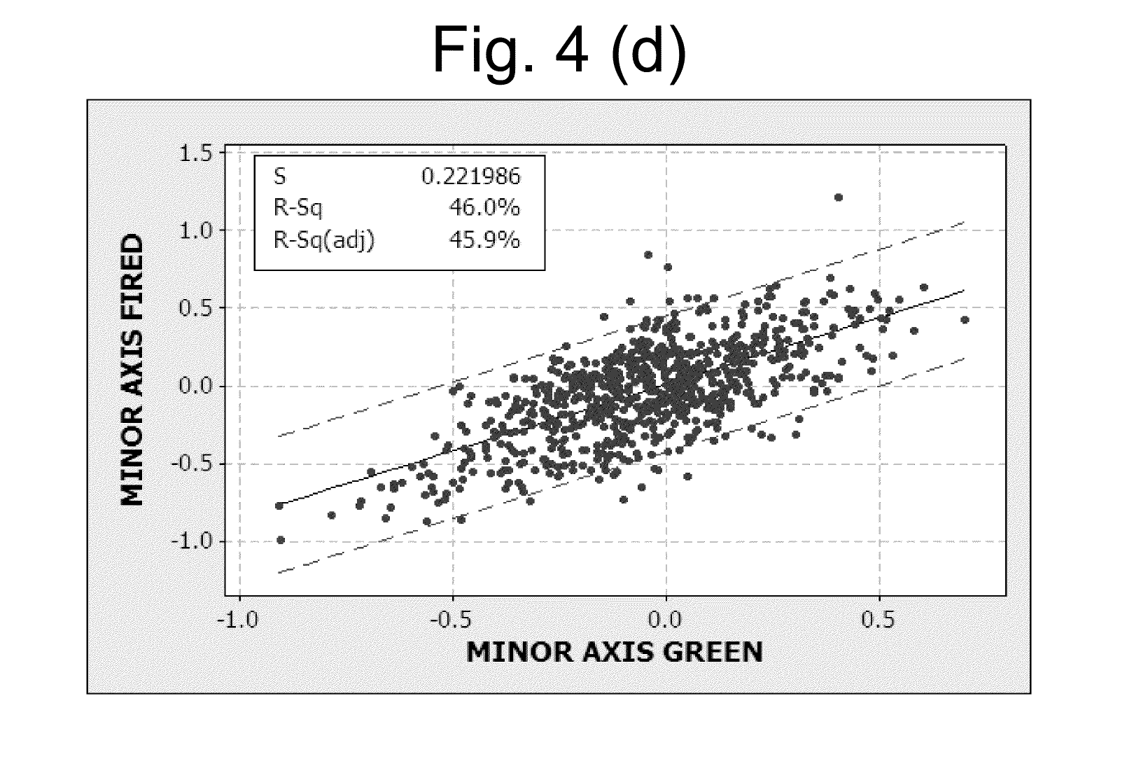

The relationships between green and fired ceramic bodies determined from standard LGCMM parameters are shown in FIGS. 4a-d. Template measurements for fired (“Template F”) ceramic bodies are plotted against those of green (“Template G”) ceramic bodies in FIG. 4a. Tubegauge measurements for fired (“Tubegauge F”) ceramic bodies are plotted against those of green (“Tubegauge G) ceramic bodies in FIG. 4b. Major axis length measurements for fired (”Major Axis F”) ceramic bodies are plotted against those of green (“Major Axis G) ceramic bodies in FIG. 4c. Minor axis length measurements for fired (”Minor Axis F″) ceramic bodies are plotted against those of green (“Minor Axis G) ceramic bodies in FIG. 4d. As can be seen from the figures, the correlation between fired and green ceramic bodies of these parameters is low, with correlation coefficients ranging from 22% (FIG. 4b) up to 46% (FIG. 4d).

The contribution of shape components to the contour shape of the ceramic body is then quantified. In one embodiment, the determination of the shape component contributions is determined by measuring a plurality of cross-sectional contours of the ceramic body. In one non-limiting example, at least three cross-sectional contours are measured from the bottom to the top of the ceramic body. Within any one of those cross-sectional contours, also referred to as “planes,” there is a plurality of measured values or points, also referred to herein as “measured locations,” equally spaced around the periphery of the ceramic body. In one non-limiting example, each cross-sectional contour contains 24 such measured values of the deviation of the contour of the body from a predetermined contour shape. These measured locations capture off-axis contour deviations that are not adequately captured by the current laser gauge parameterizations (i.e., major axis length, minor axis length, template, and/or tubegauge). Because these measured locations represent the periphery of a plane through a rigid body, they must be inter-correlated with each other; i.e., they are not independent of each other.

A small number of uncorrelated metrics is generated from a significantly larger set of inter-correlated measurements by multivariate statistical analysis techniques known in the art. Such statistical analysis techniques include, but not limited to, factor analysis, regression analysis, partial least squares analysis, principal component regression analysis, principal components analysis, and the like. These new uncorrelated metrics can then be used during the forming process for shape control and variability reduction. A set of independent principal components is thus created using the measured locations. Each of these independent principal components represents a particular type of deviation from the perfect, or target, contour of the ceramic body.

In one embodiment, principal components analysis (PCA) is used to generate a small number of uncorrelated metrics from a significantly larger set of inter-correlated measurements. PCA is described in “Principal Components and Factor Analysis: Part I—Principal Components,” by J. Edward Jackson (Journal of Quality Technology, Vol. 12, pp. 201-213 (1980)); “Principal Components and Factor Analysis: Part II—Additional Topics Related to Principal Components,” by J. Edward Jackson (Journal of Quality Technology, Vol. 13, pp. 46-58 (1981)); and “Principal Components and Factor Analysis: Part III—What is Factor Analysis?” by J. Edward Jackson (Journal of Quality Technology, Vol. 13, pp. 125-130 (1981)), the contents of which are incorporated herein by reference in their entirety.

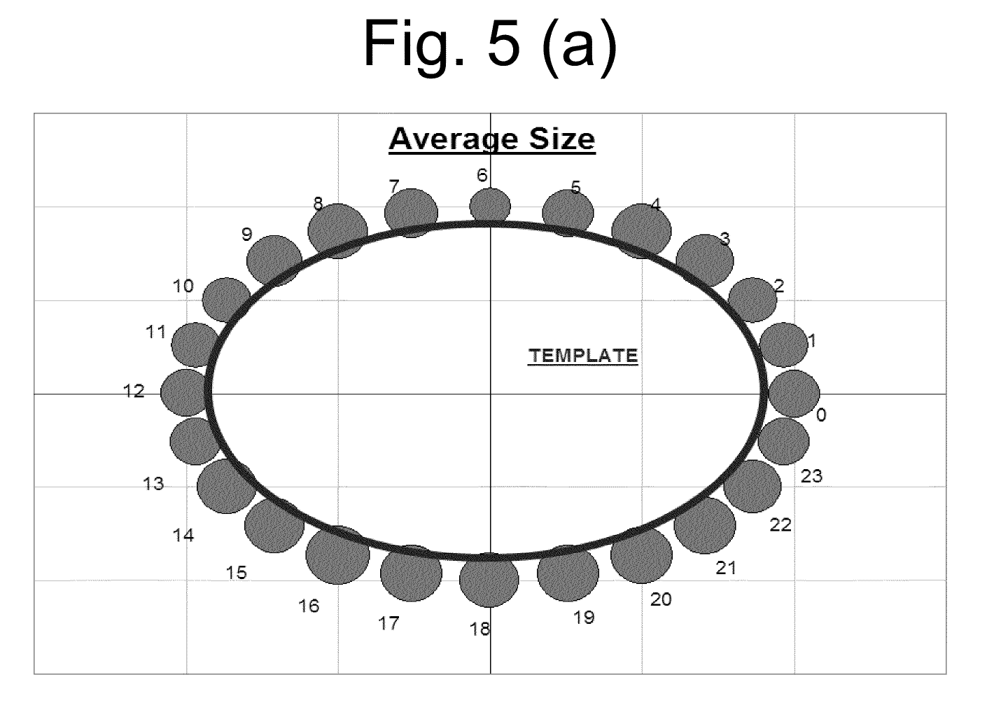

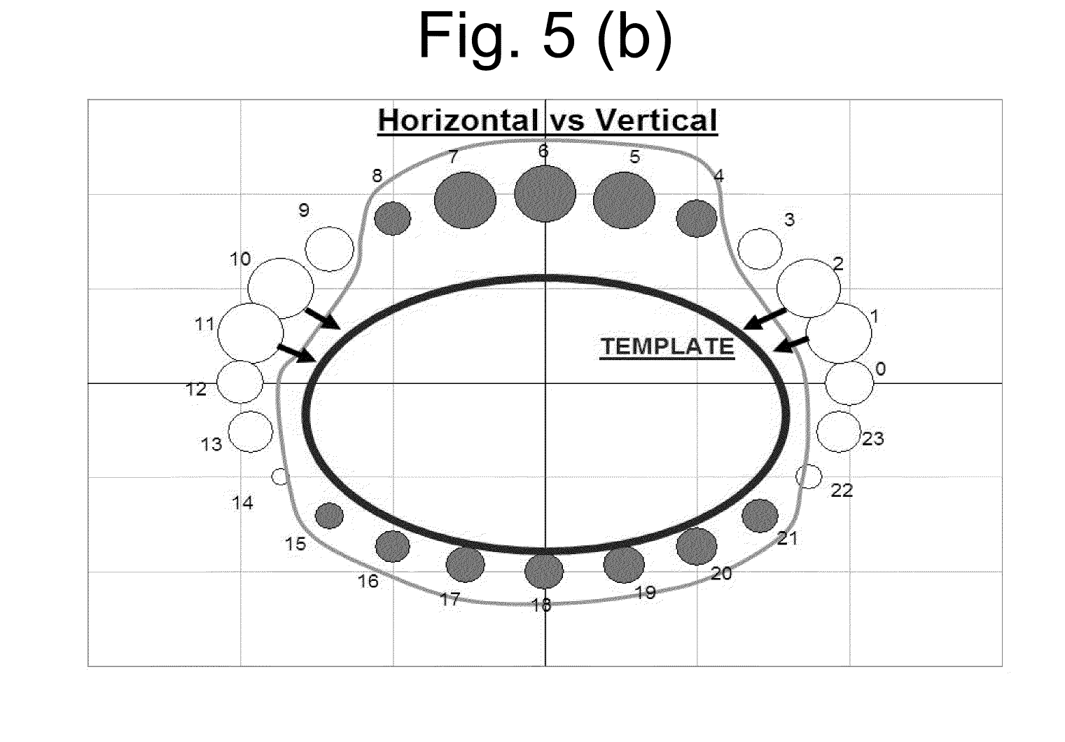

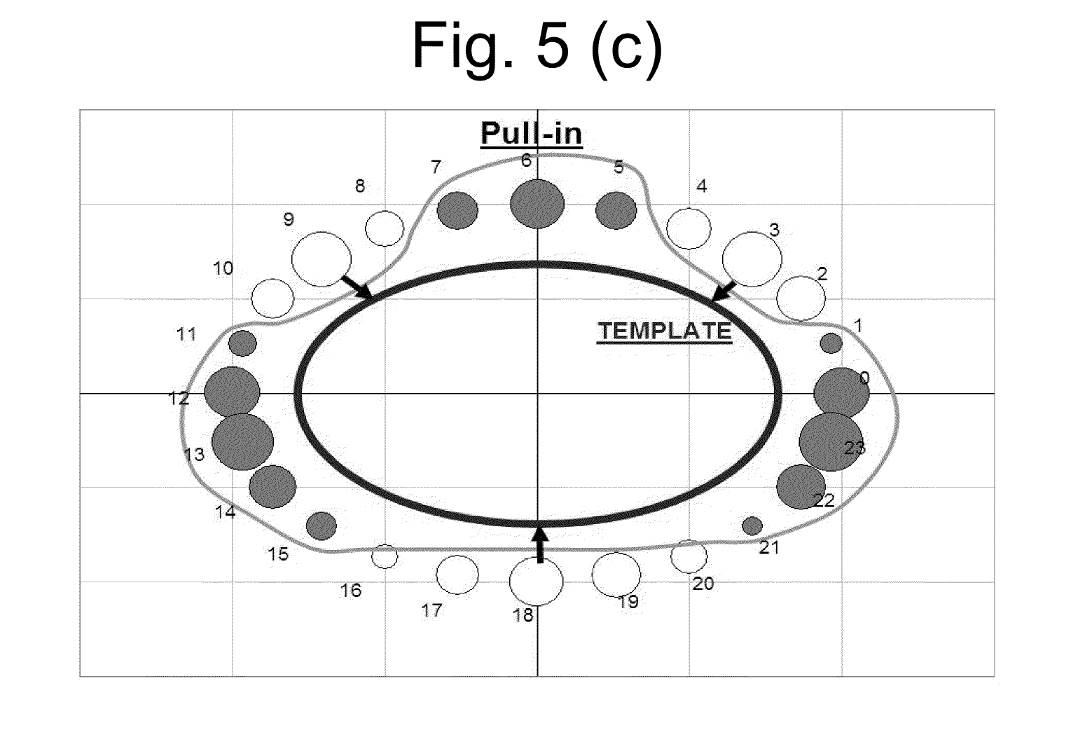

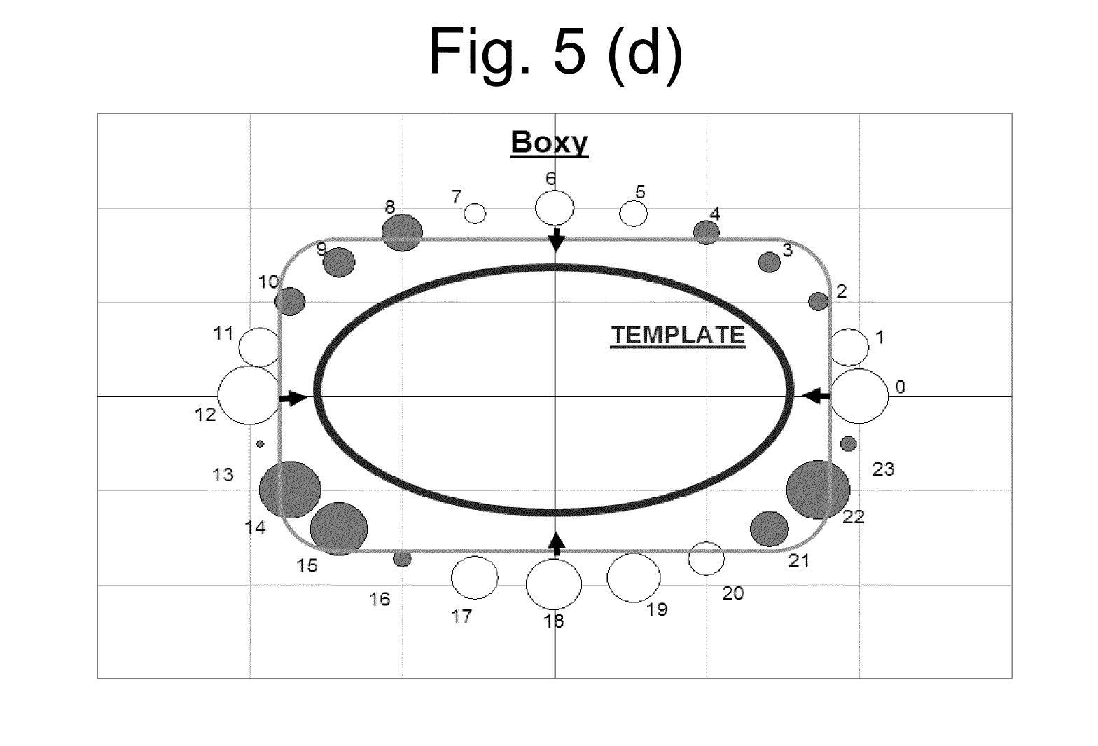

Examples of results generated by PCA for the shape families shown in FIGS. 3a-d are shown in FIGS. 5a-d. Principal component analysis was performed using cross-sectional LCGMM contour data that were obtained for ceramic bodies having oval cross-sections. The measurements were obtained for both green and fired ceramic bodies. The measurements obtained for the green bodies represent bodies that have been dried but not been fired, whereas the fired ceramic bodies had been fired in a kiln. The original 24 dimensions (measured locations) were reduced to five or six independent metrics or principal components (PCs). A plot of the loadings of each principle component on to the 24 measured locations showed patterns around the periphery of the oval part. The PCs were identified with different types of known contour issues for which no quantifiable metrics were known. These principal components of the green and fired bodies are also referred to as green or fired “shape families” or “shapes” and are combined to obtain original shapes to within a confidence level of at least 90%.

Over 90% of the variation in the contour data was accounted for in six green shapes, and only five fired shapes needed to be retained to explain the same amount of variation. The exact number of shapes and the fundamental nature of those shapes will vary from one ceramic body to another.

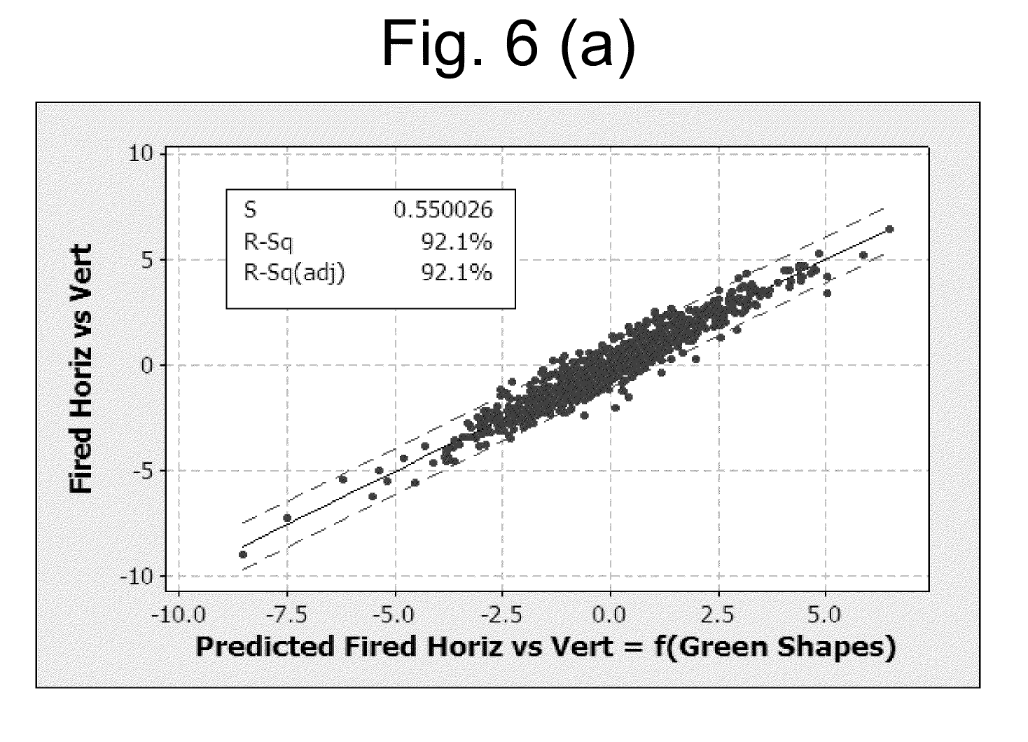

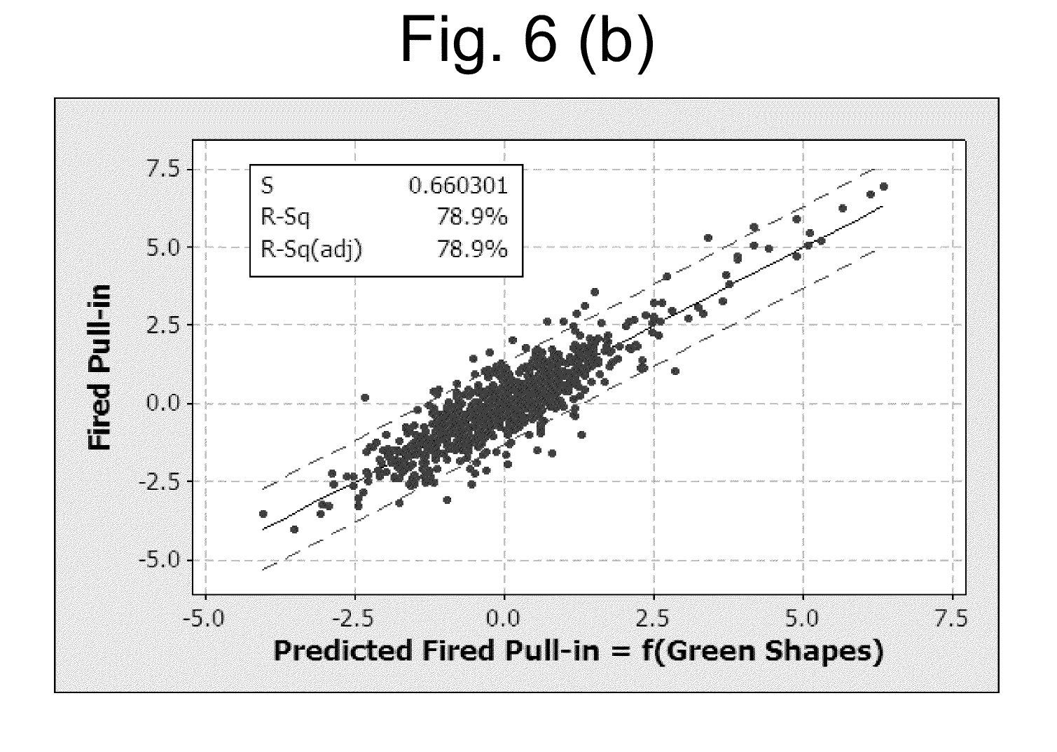

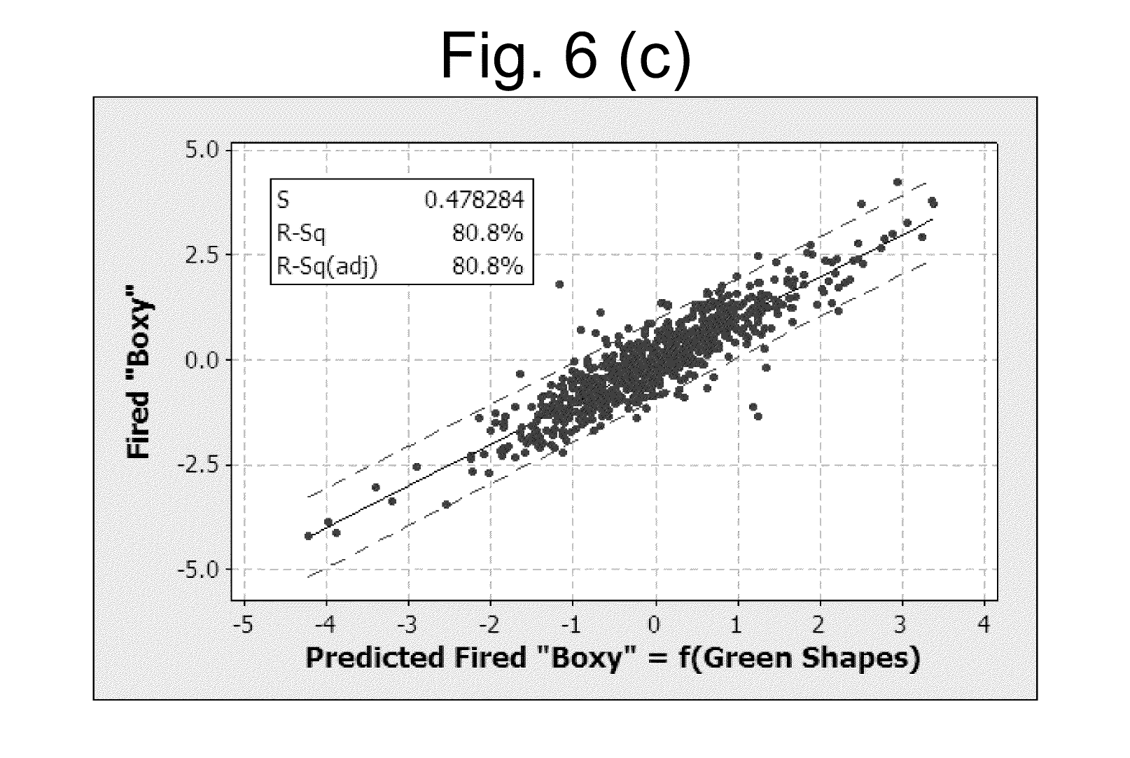

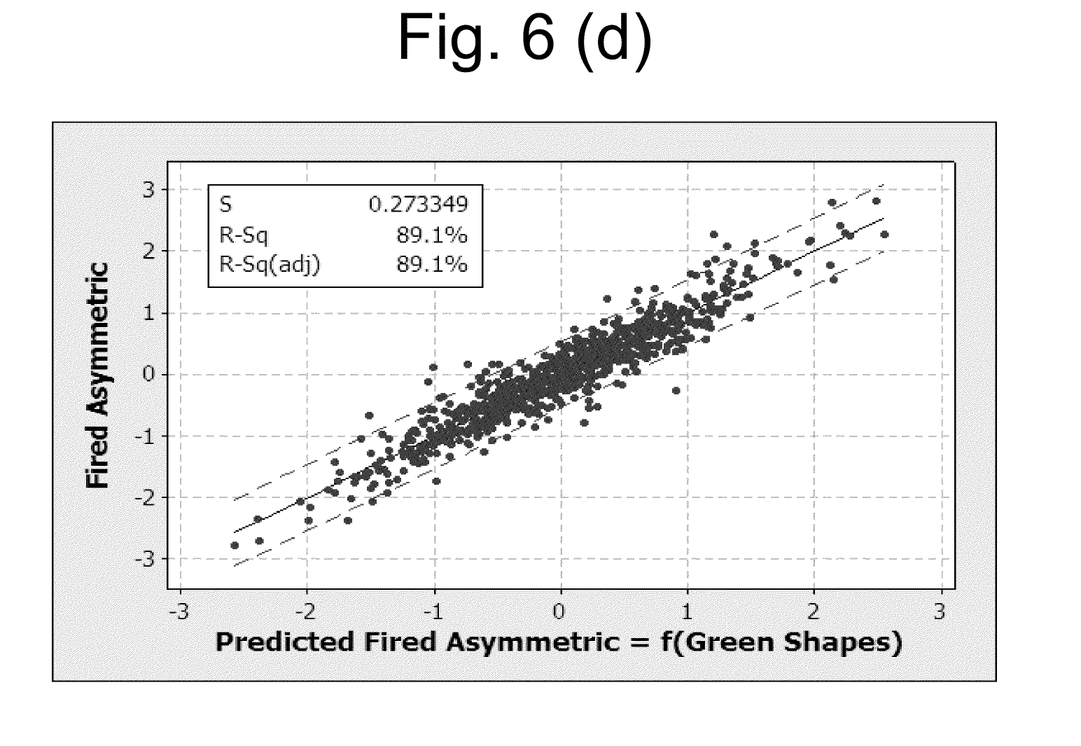

FIGS. 5a-d are plots of the loadings of each principle component onto the 24 measured locations showed patterns around the periphery of the oval part for the four shape families shown in FIGS. 3a-d. In each of FIGS. 5a-d, the template contour is surrounded by circles denoting the principal component loadings for each of the 24 measured locations. The magnitude positive/negative values of the principal component loadings are represented by the color and size of the circles surrounding the Template contour—i.e., the largest contour that can completely contained within the measured periphery of the ceramic body. Dark circles denote principal component loadings that are greater than the target contour, and open circles denote principal component loadings that are less than the target contour.

Whereas previous methods do not provide locations of specific deviations from the target contour, the present methods identify shape families and the locations of specific deviations from the target contours. Moreover, the methods described herein directly correlate predictions in the formative state of the ceramic body with the shape of the ceramic body in its final, fired state. Based on the PCA of the measured locations, fired shapes of ceramic bodies can be predicted from the corresponding green shapes. Specifically, if each shape is numbered 1, 2, . . . , k, the best predictor of the k^{th} fired shape is the k^{th} green shape. This means that the contour of the green ceramic shape is essentially the same as that of the fired ceramic shape and that the shape families are preserved through drying and firing of the ceramic bodies. Using the shape/shape families described above and plotted in FIGS. 5a-d, relationships between the green bodies and fired bodies are plotted in FIGS. 6a-d. The data plotted in FIGS. 6a-d show that there is a high correlation between fired and green ceramic bodies for the shape families shown, with correlation coefficients ranging from 79% (FIG. 6b) up to 92% (FIG. 6a). In contrast, the correlations between fired and green ceramic bodies with Template, Tubegauge, and Major Axis and Minor Axis Lengths are low (FIGS. 4a-d), as evidenced by correlation coefficients ranging from 22% up to 46%. The relationships between shape families described herein green and fired ceramic bodies for each of the shape families can therefore be more accurately predicted by principal component analysis than by conventional means such as Template, Tubegauge, and Major Axis and Minor Axis Lengths.

Due to the strong linkage between green and fired shapes, it is possible to exert a high degree of control of the fired shape during the forming/manufacturing process that produces the green body/shape. The quantified shape component contributions can be correlated with contour issues, which in turn are known to be responsive to—or affected by—certain manufacturing or processing parameters. Such parameters can be adjusted to resolve such contour issues.

Manufacturing parameters that can be adjusted to resolve contour/shape issues are typically related to composition of the ceramic batch material that is formed into the ceramic body, temperature control of the batch during forming, rheology of the batch material, and hardware and forming processes. Composition parameters include, but are not limited to, water content, particle size, and impurity levels. Temperature control of the batch material during formation generally relates to differences in temperatures between the skin or outer layer and the bulk of the ceramic body during formation. Rheology generally relates to the resistance or, conversely, the ability of the ceramic batch to flow. Hardware and forming processing parameters relate to the specific process that is used to form the ceramic body, and include the rheological regime in which a particular process operates. Extrusion parameters, for example, include the speed and pressure under which the ceramic batch material is extruded, extrusion barrel temperature, revolution speed of extrusion screws, and shrink plate dimensions.

In one embodiment, a first ceramic body is formed, and the shape component contributions are quantified based on the measured locations obtained by measuring cross-sectional contours of on the first ceramic body. The measured locations capture deviations in the contours of the first ceramic body. Using principal component analysis, independent components representing different types of deviations are generated from the measured locations. The deviations are associated with certain manufacturing or processing parameters which can be adjusted in the manufacture or processing of subsequent ceramic bodies to minimize or eliminate such deviations. For example, where the ceramic body is formed by extrusion, the size of the fired shape is currently controlled at the extrusion end via a shrinkage program. Given the input of PCA performed on contour deviation of a first ceramic body, the shrinkage program can be adjusted to minimize such deviation in subsequently manufactured ceramic bodies.

In one embodiment, the methods described herein enable green and/or fired ceramic bodies to have a contour that is within ±1.50 mm of a specified contour and, in another embodiment, such bodies have a contour that is within ±1.00 mm of a specified contour. In particular, at least one of the minimum template measurement and the maximum tube gauge measurement for the ceramic body is within ±1.50 mm of a specified contour and, in another embodiment, within ±1.00 mm of a specified contour

A method of controlling contour shapes of ceramic bodies is also provided. The method includes providing a first ceramic body. The first ceramic body, as with subsequently formed ceramic bodies, can be a green ceramic body or a fired ceramic body produced by those means known in the art, as previously described herein. Deviations from a predetermined shape are the measured on the surface of the first ceramic body. Such deviations are correlated and can, in one embodiment, be measured perpendicular to the surface of the first ceramic body and are used to obtain correlated measured locations. The correlated deviations are then transformed into independent principal components or metrics, which are combined to obtain an original shape. Manufacturing parameters for making the ceramic bodies are then adjusted based upon the independent principal components to control the contour shape of a second ceramic body, such that the contour shape of the second ceramic body is within a tolerance of a predetermined, or target, contour shape. Specific independent principal components are addressed by specific process actions. For example, pull-in (FIG. 5c) deviations can be addressed by adjusting rheology-related parameters, including feed rate, barrel temperature, or the like.

While typical embodiments have been set forth for the purpose of illustration, the foregoing description should not be deemed to be a limitation on the scope of the disclosure or appended claims. Accordingly, various modifications, adaptations, and alternatives may occur to one skilled in the art without departing from the spirit and scope of the present disclosure or appended claims.

1. A method of making ceramic bodies, the method comprising the steps of:
a. providing a first ceramic body, the first ceramic body having a contour shape;
b. quantifying shape component contributions to the contour shape; and
c. adjusting manufacturing parameters for making subsequent ceramic bodies based on the quantified shape contributions to the contour shape.

2. The method of claim 1, wherein the step of quantifying shape component contributions to the contour shape comprises:
a. obtaining measured locations by measuring a plurality of cross-sectional contours of the ceramic body, wherein the measured locations capture deviations in the contour shape and are inter-correlated with each other;
b. creating a set of independent principal components from the measured locations, wherein each of the independent components represents a deviation type.

3. The method of claim 1, wherein the step of adjusting manufacturing parameters for making subsequent ceramic bodies based on the quantified shape contributions to the contour shape further comprises controlling contour shapes of the subsequent ceramic bodies.

4. The method of claim 3, wherein the step of controlling contour shapes of the subsequent ceramic bodies comprises controlling contour shapes of the subsequent ceramic bodies such that the contour shapes are within a tolerance of a predetermined contour shape.

5. The method of claim 4, wherein the contour shapes are within ±1.50 mm of the predetermined contour shape, as determined by at least one of a minimum template measurement and a maximum tube gauge measurement.

6. The method of claim 1, wherein the ceramic bodies and the first ceramic body are green ceramic bodies.

7. The method of claim 1, wherein the step of providing a first ceramic body comprises extruding the first ceramic body, and wherein the subsequent ceramic bodies are extruded.

8. The method of claim 1, wherein the manufacturing parameters comprise at least one of composition of the ceramic body, extrusion barrel temperature, revolution speed of extrusion screws, and shrink plate dimensions.

9. The method of claim 1, wherein the shape has a predetermined pattern of radial deviations about a target contour.

10. The method of claim 1, wherein each of the ceramic bodies comprise at least one of cordierite, aluminum titanate, an inorganic carbide, zeolilte, and combinations thereof.

11. The method of claim 1, wherein the ceramic bodies form one of a diesel particulate filter and a substrate for a catalytic filter.

12. A method of controlling contour shapes of ceramic bodies, the method comprising the steps of:
a. providing a first ceramic body;
b. measuring deviations from a predetermined contour shape on the surface of the first ceramic body, wherein adjacent deviations are correlated to each other;
c. transforming the correlated deviations into independent principal components;
d. combining the independent principal components to obtain an original shape; and
e. adjusting manufacturing parameters for the ceramic bodies based on the independent principal components obtained for the first ceramic body to make a second green ceramic body having a contour shape that are within a tolerance of a predetermined contour shape.

13. The method of claim 12, wherein the step of combining independent principal components comprises linearly combining the independent principal components.

14. The method of claim 12, wherein the manufacturing parameters comprise at least one of extrusion barrel temperature, revolution speed of extrusion screws, and shrinkplate dimensions.

15. The method of claim 12, wherein the shape has a predetermined pattern of deviations about a target contour.

16. The method of claim 12, wherein each of the ceramic bodies comprise at least one of cordierite, aluminum titanate, silicon carbide, and combinations thereof.

17. The method of claim 12, wherein the contour shape of the second ceramic body is within ±1.50 mm of the predetermined contour shape, as determined by at least one of a minimum template measurement and a maximum tube gauge measurement.

18. The method of claim 12, wherein the step of providing the first ceramic body comprises extruding the first ceramic body.

19. The method of claim 12, wherein the first ceramic body and the second ceramic body are in a green state.

20. A method of making a plurality of green bodies comprising a ceramic material, the method comprising the steps of:
a. providing a first green ceramic body;
b. measuring deviations from a predetermined contour on the surface of the ceramic body, wherein adjacent deviations are correlated to each other;
c. transforming the correlated deviations into independent principal components;
d. linearly combining the independent principal components to obtain an original shape; and
e. adjusting manufacturing parameters for making a second green body based on the principal components to make a second green ceramic body having contours that are within a tolerance of the predetermined contour.

21. The method of claim 20, wherein the contour shape of the second green ceramic body is within ±1.50 mm of the predetermined contour shape, as determined by at least one of a minimum template measurement and a maximum tube gauge measurement.

22. The method of claim 20, wherein the manufacturing parameters comprise at least one of extrusion barrel temperature, revolution speed of extrusion screws, and shrinkplate dimensions.

23. The method of claim 20, wherein the shape has a predetermined pattern of deviations about a target contour.

24. The method of claim 20, wherein the ceramic material comprises at least one of cordierite, aluminum titanate, an inorganic carbide, zeolite, and combinations thereof.

25. The method of claim 20, wherein the step of providing the first ceramic body comprises extruding the first ceramic body.
